(19) United States
(12) Patent Application Publication
(10) Pub. No.: US 2007/0136732 A1
(43) Pub. Date: Jun. 14, 2007

(54) Resource assigning method and diagnostic system of arithmetic circuit using the same

(75) Inventors: Hiroyuki Saitoh, Kawasaki (JP); Hideyuki Tsutsumi, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/388,610

(22) Filed: Mar. 24, 2006

(30) Foreign Application Priority Data
Dec. 13, 2005 (JP) 2005-359212

(51) Int. Cl. G06F 9/46

(52) U.S. Cl. 718/104

(57) ABSTRACT

A resource assigning method and a diagnostic system of an arithmetic circuit using the same are provided, which can determine the normality of the arithmetic circuit in real time during system operation without increasing the scale of the apparatus. The method includes the steps of setting a rate b of diagnosis target resources depending on a rate a of resources used in actual operation; and setting a margin resource rate c in advance to accommodate to fluctuating resources thereby to obtain the rate b of diagnosis target resources as b %=100%−a %−c %.

### CROSS-REFERENCE TO RELATED APPLICATIONS

This application is based upon and claims the benefit of priority from the prior Japanese Patent Application No.2005-359212, filed on Dec. 13, 2005, the entire contents of which are incorporated herein by reference.

### BACKGROUND OF THE INVENTION

1. Field of the Invention

The present invention relates to a resource assigning method and a diagnostic system of an arithmetic circuit using the same.

2. Description of the Related Art

A mobile communication base station system control apparatus, etc. are equipped with an arithmetic circuit such as a voice codec circuit, and it is important for reliability of a system to determine whether such an arithmetic circuit operates properly or not.

Since input data of the arithmetic circuit change continually during operation of mobile communication, it cannot be determined only from output whether the result is normal or not.

Therefore, to determine whether the arithmetic circuit operates properly or not, the arithmetic circuit may be configured to be duplicated, triplicated, etc. If outputs for the same input signal are the same in the duplicated or triplicated circuits, it can be determined that the circuit operates properly. However, since the scale of the circuit increases in such countermeasures, this is not practical countermeasures.

Therefore, to determine the normality of the arithmetic circuit, a functioning unit equipped with the arithmetic circuit has been once detached from the operation and a test is performed in a test vector where arithmetic results can be known in advance in an offline state. However, in this method, it is problematic that the normality of the arithmetic circuit during the actual operation cannot be diagnosed.

The technology relating to the normality diagnosis of a circuit includes an invention disclosed in Japanese Patent Application Laid-Open Publication No. 1996-313603. The invention disclosed in Japanese Patent Application Laid-Open Publication No. 1996-313603 is configured for a test performed at the final inspection step in LSI manufacturing. This configuration is characterized in that a data signal is stored with the use of an available area in ROM provided in LSI and a test mode is set by decoding the data signal.

As described above, any conventional technology does not determine normality of an arithmetic circuit during system operation in a mobile communication base station system control apparatus, etc.

### SUMMARY OF THE INVENTION

It is therefore the object of the present invention to provide a resource assigning method and a diagnostic system of an arithmetic circuit using the same, which can determine the normality of the arithmetic circuit in real time during system operation without increasing the scale of the apparatus.

In order to achieve the above object, according to a first aspect of the present invention there is provided a resource assigning method, wherein a rate b of diagnosis target resources is set depending on a rate a of resources used in actual operation, wherein a margin resource rate c is set in advance to accommodate to fluctuating resources, and wherein the rate b of the diagnosis target resources is obtained as b %=100% −a %−c %.

In a time zone where resource usage is increased relative to average resource usage, the margin resource rate c may be set to a value larger than the average resource usage, and in a time zone where resource usage is decreased relative to the average resource usage, the margin resource rate c may be set to a value smaller than the average resource usage. When an average resource usage is changed to a direction of increasing relative to daily average resource usage during a predetermined resource usage monitoring time period, the margin resource rate c may be increased at a certain rate from a prescribed value. A monitoring time period may be reduced depending on the increase rate of the average resource usage during the predetermined resource usage monitoring time period. The margin resource rate c may be increased when the average resource usage is increased by a predetermined value or more during the predetermined resource usage monitoring time period for a predetermined number of times consecutively. When the rate b of the diagnosis target resources becomes smaller than currently diagnosed resources by a predetermined rate, the diagnosed resources may be released. The determination of the rate b of the diagnosis target resources may be triggered in set determination cycles. A resource rate value may be set along with the determination cycle, and when the rate b of the diagnosis target resources is checked, the diagnosis may be performed if the rate b is equal to or higher than the set resource rate value, and if the rate b is less than the set resource rate value, the diagnosis may not be performed and the determination may be performed at the next determination cycle. When the value of the rate b is checked at each of the determination cycles, the diagnosis may be performed if the rate b is equal to or higher than the set value, and if the rate b is less than the set value, the same determination may be performed after a shorter time period t.

In order to achieve the above object, according to a second aspect of the present invention there is provided an arithmetic circuit diagnosis system comprising a plurality of arithmetic circuit units each of which includes an arithmetic circuit; and a CPU unit; wherein the CPU unit sets a rate b of diagnosis target arithmetic circuit units depending on a rate a of arithmetic circuit units used in actual operation among the plurality of the arithmetic circuit units, wherein a margin resource rate c is set in advance to accommodate to a fluctuating usage rate of the arithmetic circuit units, and wherein the rate b of the diagnosis target arithmetic circuit units is obtained as b %=100%−a %−c %.

Each of the plurality of the arithmetic circuit units may include a test vector generator and a check circuit, and the diagnosis target arithmetic circuit may be controlled to perform an arithmetic process of a test vector from the test vector generator instead of normal data at the corresponding arithmetic circuit with the CPU unit to determine whether the arithmetic circuit is normal or abnormal by determining the result with the check circuit.

According to the invention, with regard to diagnosis of resources such as an arithmetic circuit in a system apparatus, the normality of the arithmetic circuit can be determined in real time during system operation without increasing the scale of the apparatus.

### BRIEF DESCRIPTION OF THE DRAWINGS

The above and other objects, aspects, features and advantages of the present invention will become more apparent from the following detailed description when taken in conjunction with the accompanying drawings, in which:

FIG. 1 is a block diagram of a configuration example of an arithmetic circuit such as an audio codec circuit in a mobile communication base station system control apparatus, etc., to which a resource assigning method of the present invention is applied;

FIG. 2 is a process flow in the resource assigning method of the present invention;

FIG. 3 is a table that shows changes in a rate b of diagnosis target resources in time zones;

FIG. 4 is a flow of a method of obtaining a margin resource rate that is a third embodiment;

FIG. 5 is a flow of a fourth embodiment considering the case that the resource usage is drastically changed due to some events, etc;

FIG. 6 is a fifth embodiment and shows a process corresponding to the case that a rate “a” of resources used in actual operation is drastically increased because throughput is drastically increased in the fourth embodiment;

FIG. 7 is a six embodiment and an embodiment considering the case that the resource usage fluctuates and repeats increasing and decreasing;

FIGS. 8A and 8B show an embodiment that performs control for releasing the resource during diagnosis;

FIG. 9 is a flow for describing a basic process for a diagnosis cycle of a resource amount;

FIG. 10 is a process flow when a diagnosis target resource amount b is set in station data in addition to a diagnosis cycle T; and

FIG. 11 is a process flow of an embodiment for reducing process time relative to the embodiment of FIG. 10.

### DESCRIPTION OF THE PREFERRED EMBODIMENTS

Description will be made of an embodiment of the present invention. The embodiment is for the purpose of understanding the present invention and is not limitation of the technical scope of the present invention, which includes equivalents of the claims.

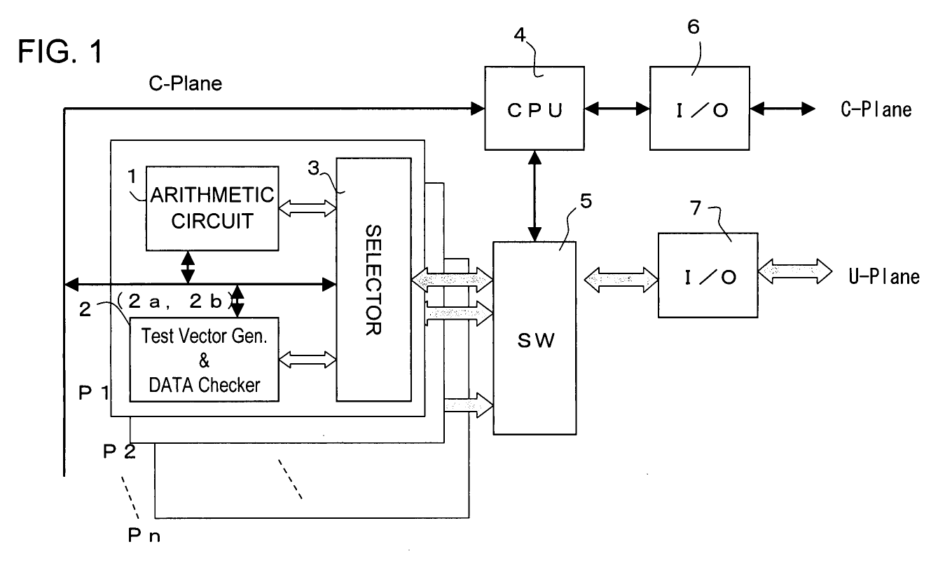

FIG. 1 is a block diagram of a configuration example of an arithmetic circuit such as an audio codec circuit in a mobile communication base station system control apparatus, etc., to which a resource assigning method of the present invention is applied.

In FIG. 1, one apparatus is constituted by a plurality n of panels P1 to Pn.

Each of a plurality n of panels P1 to Pn has an arithmetic circuit 1, a test vector generator and data check circuit 2, and a selector 3.

A CPU unit 4 and a changeover switch 5 are included externally. A channel setting signal (C-Plane) and a normal operation (U-Plane) signal is input/output through an I/O interface circuits 6, 7, respectively.

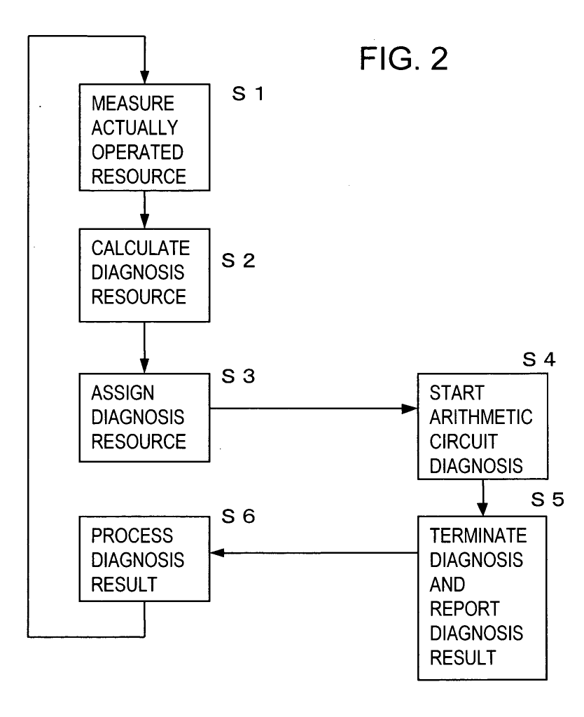

FIG. 2 is a process flow in the resource assigning method of the present invention.

The CPU unit 4 uses the channel setting signal (C-Plane) to assign actually operated resources and manages resources with a table, etc. The actually operated resources are measured from this resource management table, etc (step S1). Based on this result, an available resource (arithmetic circuit 1) is calculated and determined in a plurality of the panels P1 to Pn where an unoperated resource can be a target of diagnosis. That is, actually operated resources (arithmetic circuit 1) are measured and an unoperated resource is calculated to be diagnosis target resource and is assigned to the diagnosis target resource (step S3).

In the panel equipped with the arithmetic circuit 1 defined as the diagnosis target, the selector 3 is switched to stop the normal operation U-Plane signal (data signal) from the changeover switch 5 and the test signal from the test vector generator 2a is input to the arithmetic circuit 1. In this way, an arithmetic process is performed in the arithmetic circuit 1 for the test signal.

The output result of the arithmetic process of the arithmetic circuit 1 is reported to the data checker 2 (step S5), it is determined by the data checker 2b whether the arithmetic result is normal or abnormal (OK or NG). This determination result is received by the CPU unit 4, and in the case of NG, the arithmetic circuit 1 is set to an alarm (ALM), etc. and is excluded from resource targets for the normal operation. In the case of OK, a process of the diagnosis result is performed such as using as the operated resource until the next diagnosis is performed (step S6).

In this way, normal operation is performed in panels other than the panel equipped with the arithmetic circuit 1 defined as the diagnosis target, and the normality/abnormality can be determined for the resource defined as the diagnosis target, i.e., the arithmetic circuit 1 during operation of the apparatus.

The trigger of the diagnosis according to the present invention is controlled such that the diagnosis is performed in each cycle determined by station data, etc. or such that if a rate of resources diagnosed at relevant time is equal to or less than a predetermined rate, the diagnosis is performed at the next cycle or after a predetermined time.

Description will be made of an embodiment about obtaining a resource defined as a diagnosis target.

In a first embodiment, a rate of resources used in actual operation is assumed to be “a” and a rate of resources to be diagnosed is assumed to be “b”. To accommodate to fluctuating resources, a margin resource rate “c” is set from station data, etc.

The rate of the resources to be diagnosed can be obtained as b %=100%−a %−c %.

The rate of the resources to be diagnosed is truncated to the first decimal place to obtain the diagnosis resource as follows. In this way, the diagnosis target can be determined in process step S3 of FIG. 2. Therefore, if the actually operated resources are fluctuated, the operated resources can be assigned without lack.

b=0% (<9%)

b=10% (10% to 19%)

b=20% (11% to 29%)

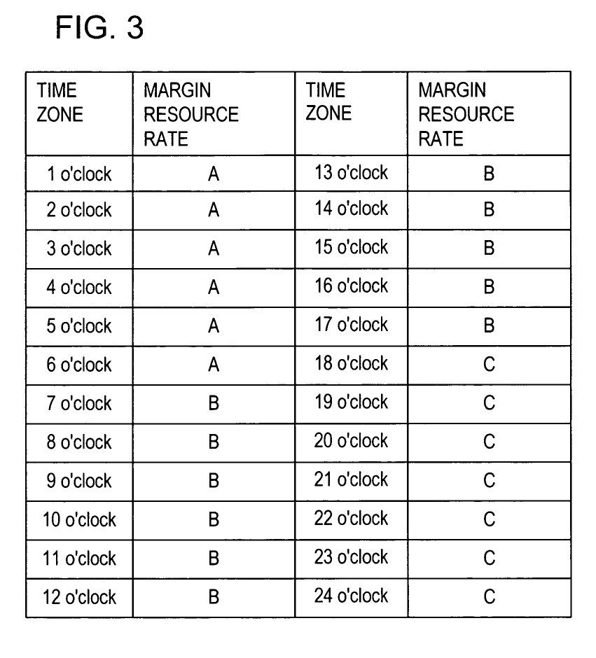

With regard to a second embodiment, since the rate diagnosed resource b is varied depending on time zones in the first embodiment when considering traffic of mobile communication, as shown in an example of a table of FIG. 3, the margin resource rate c is set to a higher value C (A<B<C) by the station data, etc., in time zones where resource usage is increased.

The diagnosis target resource rate b is controlled to be obtained by the value C set for the margin resource rate and, in the case of time zones where the margin resource rate is reduced, the diagnosis target resource rate b is controlled by a lower value A that is set by the station data, etc.

A third embodiment is a method of obtaining the margin resource rate by comparing average resources for a day and resources of a relevant time zone.

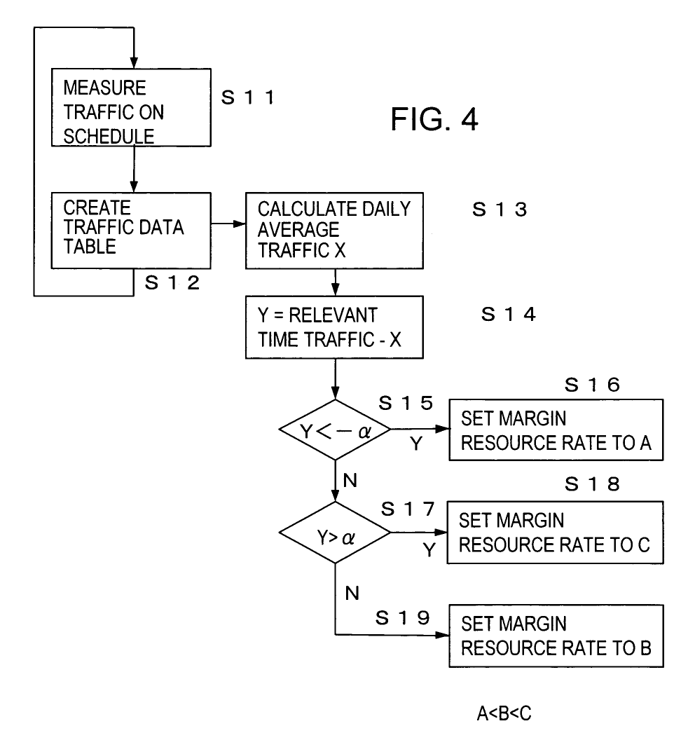

That is, in a flow shown in FIG. 4, a traffic amount is measured on schedule (step S11). A traffic data table is created to correlate traffic amounts measured at each time (step S12).

Based on this traffic data table, an average traffic amount X for a day is calculated (step S13).

A difference is obtained by comparing the calculated average traffic amount X and a traffic amount at a relevant time (step S14).

The margin resource is set depending on the degree of the difference between the daily average traffic amount X and the traffic amount at a relevant time.

When the traffic amount at a relevant time is smaller than the daily average traffic amount X by a predetermined value α (step S15, Y), the margin resource rate is set to a low value A (step S16).

On the other hand, when the traffic amount at a relevant time is larger than the daily average traffic amount X by the predetermined value α (step S17, Y), the margin resource rate is set to a highest value A (step S16).

When the traffic amount at a relevant time is larger than the daily average traffic amount X and the difference does not exceed the predetermined value α, the margin resource rate is set to a medium value B (step S16).

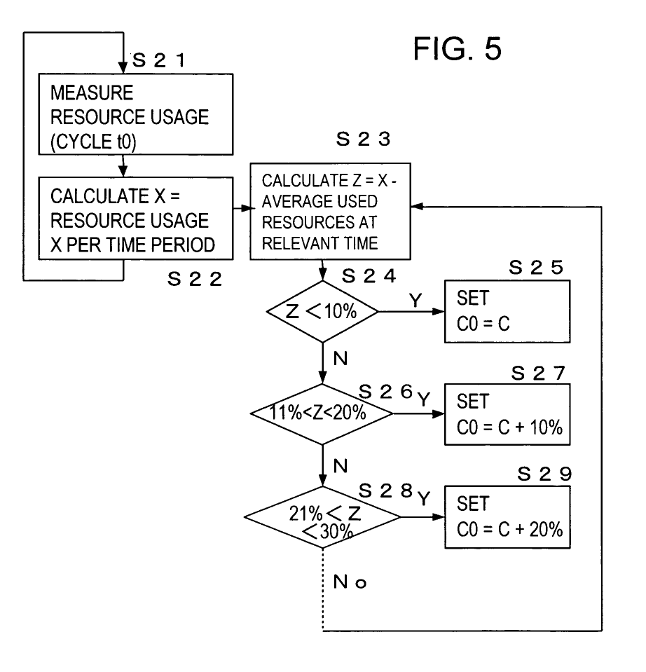

FIG. 5 is a fourth embodiment, which considers the case that the resource usage is drastically changed due to some events, etc.

At a cycle t0, the resource usage is measured (step S21) to calculate resource usage X per time period (step S22). A difference is calculated between the calculated resource usage X per time period and the average used resources at the relevant time (step S23).

When the calculated difference is less than 10%, i.e., when the change in the resource usage is less than 10% (step S24, Y), a margin resource rate is set to a standard margin resource rate value C (step S25).

When the calculated difference is in a range between 11% and 20% (step S26, Y), 10% of margin variation is added to the standard margin resource rate value C (step S27). When the calculated difference is in a range between 21% and 30% (step S28, Y), 20% of larger margin variation 2 is added to the standard margin resource rate value C (step S29).

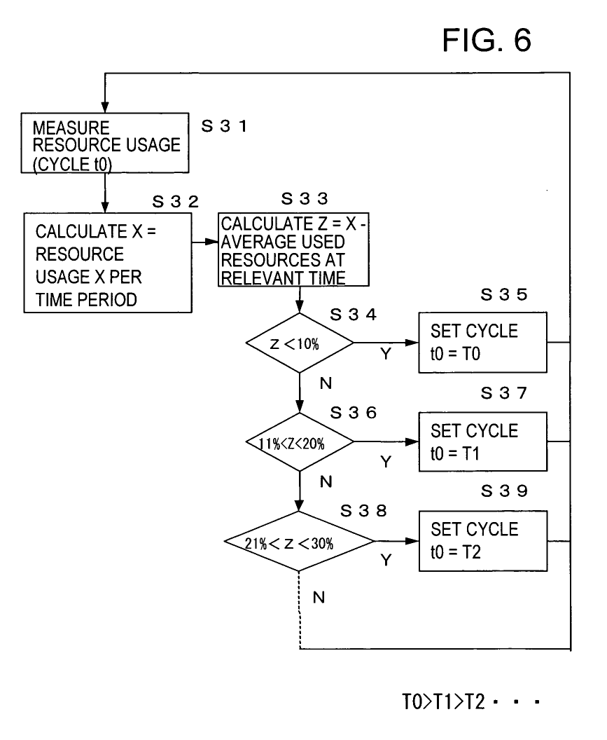

FIG. 6 is a fifth embodiment and shows an embodiment process corresponding to the case that a rate “a” of resources used in actual operation is drastically increased because throughput is drastically increased in the fourth embodiment shown in FIG. 5.

At a cycle t0, the resource usage is measured (step S31) to calculate resource usage X per time period (step S32). A difference is calculated between the calculated resource usage X per time period and the average used resources at the relevant time (step S33).

When the calculated difference is less than 10%, i.e., when the change in the resource usage is less than 10% (step S34, Y), a measurement cycle t0 is set to T0 and a margin resource rate is set to a standard margin resource rate value C (step S35).

When the calculated difference is in a range between 11% and 20% (step S36, Y), 10% of margin variation is added to the standard margin resource rate value C and the measurement cycle t0 is set to T1 (<T0) (step S27).

When the calculated difference is in a range between 21% and 30% (step S38, Y), 20% of larger margin variation 2 is added to the standard margin resource rate value C and the measurement cycle t0 is set to T2 (<T1<T0) (step S27).

In this way, by shortening the monitor time t0 depending on the rate of increase in the resource usage X per time period for sensitive monitoring, the lack of the actually operated resources can be avoided.

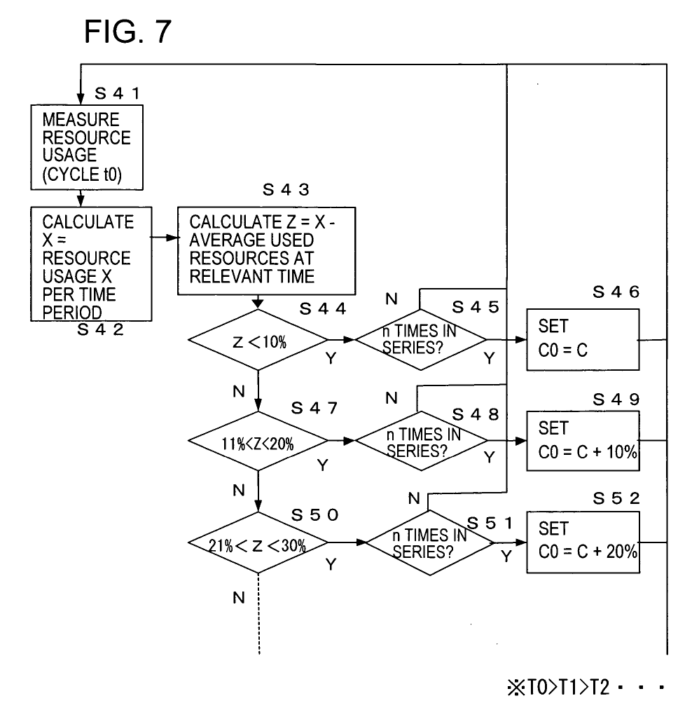

FIG. 7 is a six embodiment. This is an embodiment considering the case that the resource usage fluctuates and repeats increasing and decreasing.

In this embodiment, to prevent the diagnosis resource control from fluctuating, the control is performed such that c0 is set when a difference Z between the resource usage per time period and the average used resources at the relevant time is changed by a predetermined value or more for n times consecutively.

That is, as is the case of FIG. 5, the resource usage per time period is calculated (step S42) to obtain a difference with the average used resources at the relevant time (step S43).

When the obtained difference with the average used resources is less than 10% (step S44, Y), when the calculated difference is in a range between 11% and 20% (step S47, Y), and when the calculated difference is in a range between 21% and 30% (step S50, Y), it is determined whether each condition is satisfied for the number of times equal to or more than a predetermined number of times (steps S45, s48, s51) before performing processes for setting the margin to the standard margin c, for adding 10% to the standard margin c, and for adding 20% to the standard margin c (steps S46, S49, S52), respectively, in the embodiment shown in FIG. 5. If the predetermined number of times is not exceeded in each case, the control is performed such that the measurement cycle is not changed.

With such a control process, an appropriate process can be performed if the resource usage fluctuates and repeats increasing and decreasing.

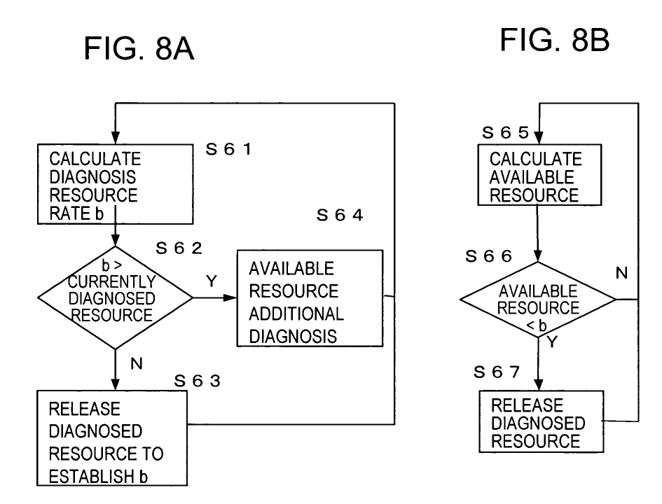

FIGS. 8A and 8B show an embodiment that performs control for releasing the resource during diagnosis. In FIG. 8A, a diagnosable target resource rate b is calculated (step S61). If the calculated diagnosable target resource rate b is smaller than the currently diagnosed resource amount (step S62, N), a portion of the diagnosed resources is controlled to be released to establish the rate b (step S63).

Contrary, if the calculated diagnosable target resource rate b is larger than the currently diagnosed resource amount (step S62, Y), available resource additional diagnosis is performed since room for available resources exists (step S64).

In the available resource additional diagnosis (step S64), as shown in FIG. 8B, when the available resource is equal to or less than a predetermined rate β (e.g. 5%) (step S66), all the resources during diagnosis are released (step S67). In this way, the control can be performed such that the diagnosis resources are used up to the predetermined rate β and such that the lack of the operation resources is not generated.

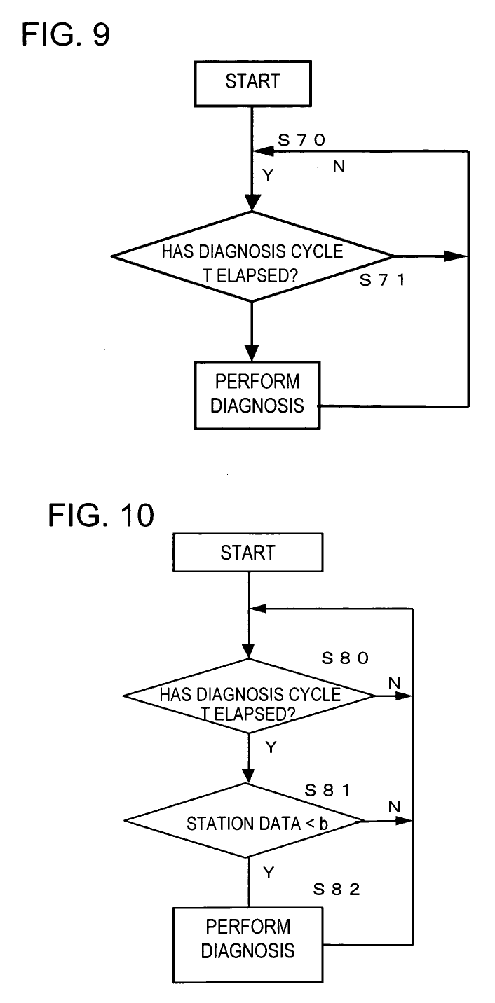

The resource amount diagnosis cycle will be discussed. As described above, the resource amount diagnosis cycle can be set in the station data. FIG. 9 is a flow for describing the basic process.

If a diagnosis cycle T is notified by the station data to the CPU unit 4, the CPU unit 4 determines if the notified diagnosis cycle T has elapsed (step S70). If the diagnosis cycle T has elapsed (step S70, Y), the diagnosis is performed and it is determined if the next diagnosis cycle T has elapsed (step S71).

FIG. 10 is a process flow when a diagnosis target resource amount b is set in the station data in addition to the diagnosis cycle T.

When the diagnosis cycle T has elapsed (step S80, Y), if the resource amount set in the station data is exceeded (step S81, Y), the diagnosis is performed (step S82).

If the resource amount set in the station data is not exceeded (step S81, N), the determination is performed again after the next diagnosis cycle T has elapsed.

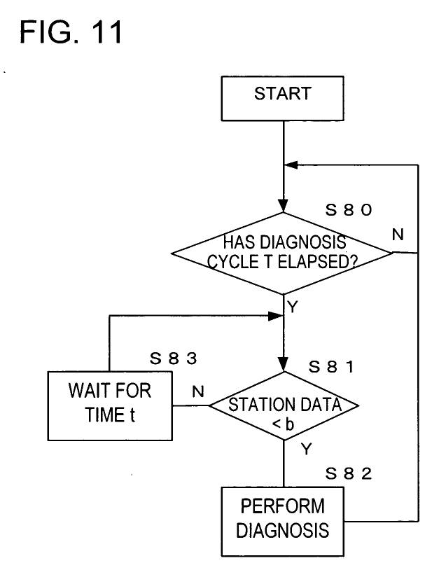

In the process of the embodiment of FIG. 10, if the resource amount set in the station data is not exceeded (step S81, N), the determination is performed again after the next diagnosis cycle T has elapsed (step S80). On the other hand, FIG. 11 is a process flow of an embodiment for reducing process time.

In FIG. 11, when the diagnosis cycle T has elapsed (step S80, Y), if the resource amount set in the station data is not exceeded (step S81, N), after waiting for the elapse of time t shorter than the diagnosis cycle T (step S83), it is determined again whether the resource amount set in the station data is exceeded or not (step S81) without waiting for the elapse of the next diagnosis cycle T. This is because the resource amount set in the station data may be exceeded before the next diagnosis cycle T and the process time can be reduced.

As described above, in the present invention, the normality of the arithmetic circuit can be checked by diagnosing in real time and an abnormal arithmetic circuit can be separated from the actual operation by setting to an alarm (ALM), etc. to contribute to enhance the reliability of the system.

While the illustrative and presently preferred embodiments of the present invention have been described in detail herein, it is to be understood that the inventive concepts may be otherwise variously embodied and employed and that the appended claims are intended to be construed to include such variations except insofar as limited by the prior art.

What is claimed is:

1. A resource assigning method comprising the steps of:
setting a rate b of diagnosis target resources depending on a rate a of resources used in actual operation; and
setting a margin resource rate c in advance to accommodate to fluctuating resources thereby to obtain the rate b of diagnosis target resources as b %=100%−a %−c %.

2. The resource assigning method according to claim 1,
wherein in a time zone where resource usage is increased relative to average resource usage, the margin resource rate c is set to a value larger than the average resource usage, and wherein in a time zone where resource usage is decreased relative to the average resource usage, the margin resource rate c is set to a value smaller than the average resource usage.

3. The resource assigning method according to claim 1,
wherein when an average resource usage is changed to a direction of increasing relative to daily average resource usage during a predetermined resource usage monitoring time period, the margin resource rate c is increased at a certain rate from a prescribed value.

4. The resource assigning method according to claim 3,
wherein a monitoring time period is reduced depending on the increase rate of the average resource usage during the predetermined resource usage monitoring time period.

5. The resource assigning method according to claim 3,
wherein the margin resource rate c is increased when the average resource usage is increased by a predetermined value or more during the predetermined resource usage monitoring time period for a predetermined number of times consecutively.

6. The resource assigning method according to claim 1,
wherein when the rate b of the diagnosis target resources becomes smaller than currently diagnosed resources by a predetermined rate, the diagnosed resources are released.

7. The resource assigning method according to claim 1,
wherein the determination of the rate b of the diagnosis target resources is triggered in set determination cycles.

8. The resource assigning method according to claim 7,
wherein a resource rate value is set along with the determination cycle and wherein when the rate b of the diagnosis target resources is checked, the diagnosis is performed if the rate b is equal to or higher than the set resource rate value, and wherein if the rate b is less than the set resource rate value, the diagnosis is not performed and the determination is performed at the next determination cycle.

9. The resource assigning method according to claim 8,
wherein when the value of the rate b is checked at each of the determination cycles, the diagnosis is performed if the rate b is equal to or higher than the set value, and wherein if the rate b is less than the set value, the same determination is performed after a shorter time period t.

10. An arithmetic circuit diagnosis system comprising:
a plurality of arithmetic circuit units each of which includes an arithmetic circuit; and
a CPU unit;
wherein the CPU unit sets a rate b of diagnosis target arithmetic circuit units depending on a rate a of arithmetic circuit units used in actual operation among the plurality of the arithmetic circuit units,
wherein a margin resource rate c is set in advance to accommodate to a fluctuating usage rate of the arithmetic circuit units, and
wherein the rate b of the diagnosis target arithmetic circuit units is obtained as b %=100%−a %−c %.

11. The arithmetic circuit diagnosis system according to claim 10,
wherein each of the plurality of the arithmetic circuit units includes a test vector generator and a check circuit,
wherein the diagnosis target arithmetic circuit is controlled to perform an arithmetic process of a test vector from the test vector generator instead of normal data at the corresponding arithmetic circuit with the CPU unit to determine whether the arithmetic circuit is normal or abnormal by determining the result with the check circuit.
